(19) United States
(12) Patent Application Publication
(10) Pub. No.: US 2010/0314357 A1
(43) Pub. Date: Dec. 16, 2010

(54) RESIN-MOLDED VACUUM VALVE

(75) Inventors: Masato KOBAYASHI, Hitachi (JP); Kenji TSUCHIYA, Hitachi (JP); Kazunori OSAWA, Konosu (JP); Akinori YOSHITANI, Washimiya (JP); Yukihiro UOZUMI, Miyashiro (JP)

Correspondence Address: BRUNDIDGE & STANGER, P.C., 2318 MILL ROAD, SUITE 1020, ALEXANDRIA, VA, 22314, US

(73) Assignee: Hitachi, Ltd.

(21) Appl. No.: 12/483,639

(22) Filed: Jun. 12, 2009

(51) Int. Cl. H01H 33/66

(52) U.S. Cl. 218/140

(57) ABSTRACT

A resin-molded vacuum valve has an internally hermetically sealed vacuum vessel, a fixed axis having a fixed electrode at one end thereof, and a movable axis having a movable electrode at one end thereof and facing the fixed axis in the vacuum vessel. The fixed and movable electrodes are fixedly and movably attached, respectively, to respective ends of the vacuum vessel with a contact therebetween. Further, a conductor connected to the fixed axis extends from a pull-out opening. First, second, and third electric field concentration alleviating shields are disposed near the fixed axis, near the movable axis, and near the pull-out opening, respectively. Buffer layers cover the outer peripheries of the vacuum valve and the conductor, and a resin insulator allows the movable axis to be movable, and buries and fixes the fixed axis, the vacuum vessel, the conductor, the buffer layers, and the electric field concentration alleviating shields.

### CROSS-RELATED APPLICATION

The present application relates to Japanese patent application serial No. 2007-099535, filed on Apr. 5, 2007, the content of which is hereby incorporated by reference into this application.

### BACKGROUND OF THE INVENTION

1. Field of the Invention

The present invention relates to a resin-molded vacuum valve formed by integrally covering inserts, which are made of different materials including ceramic and metal, and a vacuum valve with a resin insulator.

2. Description of Related Art

Prior art for resin-molded vacuum valves is described in, for example, Patent Document 1 (Japanese Patent Laid-open No. 2002-358861, entitled “vacuum valve and its manufacturing method”) and Patent Document 2 (Japanese Patent Laid-open No. 2000-294087, entitled “resin mold vacuum valve”).

In the vacuum valve and its manufacturing method described in Patent Document 1, a vacuum valve is formed by attaching a heat stress alleviating member to cover a part that needs alleviation of heat stress, the part being disposed on the outer periphery of a vacuum vessel, and then resin molding the outer periphery of the vacuum vessel; the heat stress alleviating member is a conductive heat stress alleviating member; the heat stress alleviating member is molded in advance in a ring shape so that it can be mounted around the outer periphery of the vacuum vessel by using elasticity.

In the resin mold vacuum valve described in Patent Document 2, a first fiber layer is formed by winding a roving material of glass fiber on the outer peripheries of an insulated cylinder and stationary-side end plate of a vacuum valve; another roving material is also wound, at a coarse pitch, on the first fiber layer to form a second fiber layer; a vacuum valve having these fiber layers is put in a mold, and therein epoxy resin is injected so that a resin-molded layer is formed around the outer periphery of the vacuum valve. A resin layer having a high glass of fiber density and low coefficient of thermal expansion is formed on a part near the outer periphery of the insulated cylinder, and thereby exfoliation of the interface is prevented.

Another general resin-molded vacuum valve in the prior art will be described with reference to FIG. 7. FIG. 7 schematically shows the cross section of the structure of an exemplary resin-molded vacuum valve in the prior art. The resin-molded vacuum valve 100 includes: a vacuum vessel 104, which is formed by hermetically sealing openings at both ends of an insulated cylinder 101, which is made of stainless steel, reinforced glass, ceramic, or another material, with a fixed-side end plate 102 and a movable-side end plate 103; a fixed axis 105, which is hermetically fixed to the fixed-side end plate 102 in a vacuum; a movable axis 106; a bellows 107, through which the movable axis 106 is attached to the movable-side end plate 103; and a contact 108, which can be opened and closed while the vacuum is maintained. A resin insulator 110, which is formed by curing epoxy resin or the like, is integrally cast to the outer periphery of the vacuum valve 104 through a buffer layer 109.

The buffer layer 109 protects the resin-molded vacuum valve 100, which is integrally structured, from cracks and exfoliation, as described below.

If the resin-molded vacuum valve 100 lacks the buffer layer 109, when the resin-molded vacuum valve 100 is rapidly heated or cooled, a force is applied to the resin insulator 110 due to thermal stress caused by a difference in thermal expansion coefficients between the insulated cylinder 101 and resin insulator 110. An impact force is also applied to the resin insulator 110 in an open or close operation. When this happens, cracks, interfacial exfoliation, and other problems are likely to occur, substantially lowering the product reliability of the resin-molded vacuum valve 100.

However, the resin-molded vacuum valve 100 is provided with the buffer layer 109 between the insulated cylinder 101 and resin insulator 110, reducing the risk of the occurrence of cracks and exfoliation.

The resin-molded vacuum valve 100 of this type enables a high vacuum condition to be formed in the insulated cylinder 101, producing a superior dielectric strength against a high voltage. In the high vacuum, even when an arc is generated when the contact 108 opens or closes, the arc disappears immediately, shutting off a high voltage circuit. The resin-molded vacuum valve 100 in the prior art is as described above.

Patent Document 1: Japanese Patent Laid-open No. 2002-358861 (FIG. 1)

Patent Document 2: Japanese Patent Laid-open No. 2000-294087 (FIG. 1)

### SUMMARY OF THE INVENTION

Although countermeasures for improving resistance to cracks are taken in Patent Documents 1 and 2 as well, in Patent Document 1, an expensive resin composition is used in a local area of an insert as preprocessing before the resin casting so as to prevent interfacial exfoliation, and, in Patent Document 2, low-viscosity resin is impregnated into an inner fiber layer and outer fiber layer formed around an insulated cylinder. Accordingly, in general, an increase in cost is unavoidable.

It is necessary to suppress partial discharges generated due to a concentrated electric field. There was also a demand for implementing countermeasures for this suppression with an inexpensive structure.

Resin-molded vacuum valves for which these countermeasures are taken have been used more and more in cubicle-type switching apparatuses that are required to be compact. In response to this, further reduction in costs including work man-hours and downsizing are being demanded.

The present invention addresses the above problems with the object of providing a resin-molded vacuum valve that suppresses partial discharges generated due to an electric field concentrated by shapes and due to interfacial exfoliation on inserts, such as those for a vacuum valve, that have large variations in final dimensions as in pressed products, and has improved resistance to cracks, independently of the insert material, with a reduced size.

A resin-molded vacuum valve according to the present invention comprises: a vacuum valve having an internally hermetically sealed vacuum vessel, a fixed axis having a fixed electrode at an end, and a movable axis having a movable electrode at an end, wherein the fixed electrode and the movable electrode are facing each other in the vacuum vessel, the fixed electrode being fixed to an end of the vacuum vessel, the movable electrode being movably attached to another end of the vacuum vessel, and a contact being formed between the fixed electrode and the movable electrode; a conductor connected to the fixed axis of the vacuum valve and externally extending from a pull-out opening; an electric field concentration alleviating shield disposed near the fixed axis of the vacuum valve; an electric field concentration alleviating shield disposed near the movable axis of the vacuum valve; an electric field concentration alleviating shield disposed near the pull-out opening through which the conductor externally extends; buffer layers covering the outer peripheries of the vacuum valve and conductor; and a resin insulator allowing the movable axis of the vacuum valve to be movable and burying and fixing the fixed axis of the vacuum valve, the vacuum vessel of the vacuum valve, the conductor, the buffer layers, and the electric field concentration alleviating shields there inside.

A resin-molded vacuum valve according to the present invention comprises: a first vacuum valve having a first vacuum vessel, a fixed electrode, and a movable electrode, a first contact, to which the fixed electrode and the movable electrode face, being formed in the first vacuum vessel; a second vacuum valve having a second vacuum vessel, a fixed electrode, and a movable electrode, a second contact, to which the fixed electrode and the movable electrode face, being formed in the second vacuum vessel; a third vacuum valve having a third vacuum vessel, a fixed electrode, and a movable electrode, a third contact, to which the fixed electrode and the movable electrode face, being formed in the third vacuum vessel; a branch bus connected to the fixed axis of the first vacuum valve and externally extending from a pull-out port; a feeder conductor connected to the fixed axis of the second vacuum valve and the fixed axis of the third vacuum valve and externally extending from another pull-out port; a first electric field concentration alleviating shield disposed near the fixed axis of the first vacuum valve; a second electric field concentration alleviating shield disposed near the movable axis of the first vacuum valve; a third electric field concentration alleviating shield disposed near the fixed axis of the second vacuum valve; a fourth electric field concentration alleviating shield disposed near the movable axis of the second vacuum valve; a fifth electric field concentration alleviating shield disposed near the fixed axis of the third vacuum valve; a sixth electric field concentration alleviating shield disposed near the movable axis of the third vacuum valve; a seventh electric field concentration alleviating shield disposed near the pull-out opening near the branch bus; a eighth electric field concentration alleviating shield disposed near the other pull-out opening near the feeder conductor; buffer layers covering the outer peripheries of the first vacuum valve, second vacuum valve, third vacuum valve, branch bus, and the feeder conductor; and a resin insulator allowing the movable axes of the first vacuum valve, the second vacuum valve, and the third vacuum valve to be movable and burying and fixing the fixed axes of the first vacuum valve, the second vacuum valve, and third vacuum valve, the vacuum vessels of the first vacuum valve, the second vacuum valve, and third vacuum valve, the branch bus, the feeder conductor, the buffer layers, and the electric field concentration alleviating shields there inside.

The present invention described above can provide a resin-molded vacuum valve that suppresses partial discharges generated due to an electric field concentrated by shapes and due to interfacial exfoliation on inserts, such as those for a vacuum valve, that have large variations in final dimensions as in pressed products, and has improved resistance to cracks, independently of the insert material, with a reduced size.

### BRIEF DESCRIPTION OF THE DRAWINGS

FIG. 1 illustrates the structure of a resin-molded vacuum valve in a first embodiment of the present invention.

FIG. 2 illustrates the structure of a resin-molded vacuum valve in a second embodiment of the present invention.

FIG. 3 illustrates a circuit block diagram of the resin-molded vacuum valve in the second embodiment of the present invention shown in FIG. 2.

FIG. 4 illustrates a layout of a ring-shaped electric field concentration alleviating shield used for the resin-molded vacuum valve of the embodiment of the present invention.

FIG. 5 illustrates a locked state of a ring-shaped electric field concentration alleviating shield shown in FIG. 4.

FIG. 6 illustrates the structure of a resin-molded vacuum valve in a third embodiment of the present invention.

FIG. 7 schematically shows the cross section of a resin-molded vacuum valve in the prior art.

### DETAILED DESCRIPTION OF THE PREFERRED EMBODIMENTS

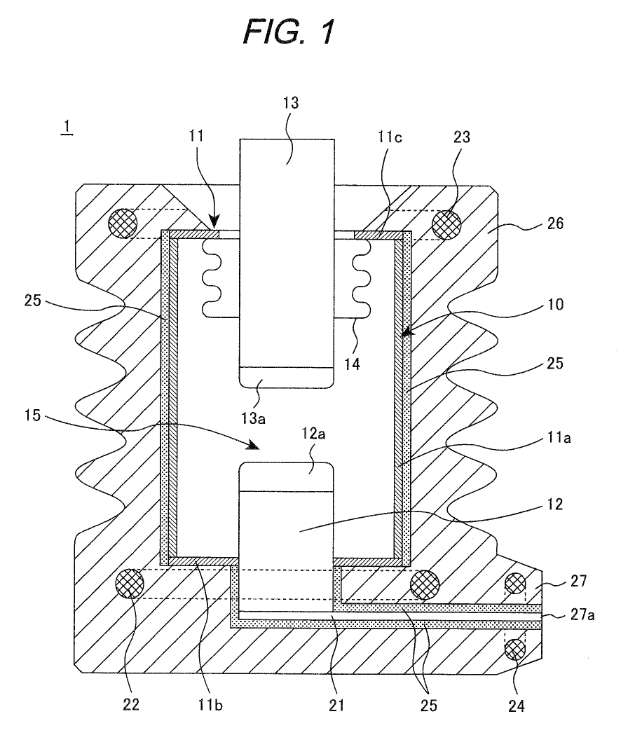

A structure of a resin-molded vacuum valve in an embodiment of the present invention will be described with reference to the drawings. FIG. 1 illustrates the structure of a resin-molded vacuum valve 1 in a first embodiment of the present invention.

The resin-molded vacuum valve 1 includes a vacuum valve 10, a conductor 21, a fixed-electrode-side electric field concentration alleviating shield 22, a movable-electrode-side electric field concentration alleviating shield 23, a conductor electric field concentration alleviating shield 24, buffer layers 25, a resin insulator 26, and a bushing 27. The vacuum valve 10 has a vacuum vessel 11, a fixed axis 12, a movable axis 13, a bellows 14, and a contact 15.

The vacuum vessel 11 further has an insulated cylinder 11a, a fixed-side end plate 11b, and a movable-side end plate 11c.

The insulated cylinder 11a is made of stainless steel, reinforced glass, ceramic, or the like so that the insulated cylinder 11a is reliably insulated.

The fixed-side end plate 11b has a hole at the center.

The movable-side end plate 11c also has a hole at the center.

The fixed axis 12 is a rod having a fixed electrode 12a at an end.

The movable axis 13 is a rod having a movable electrode 13a at an end.

The bellows 14 is shrinkable disposed, which can move the movable axis 13 with respect to the movable-side end plate 11c.

The contact 15 is formed by the fixed electrode 12a of the fixed axis 12 and the movable electrode 13a of the movable axis 13.

In the vacuum vessel 11, the fixed-side end plate 11b is attached to an opening on the fixed side (lower part) of the insulated cylinder 11a by brazing, and the movable-side end plate 11c is attached to an opening on the movable side (upper part) of the insulated cylinder 11a also by brazing; the vacuum vessel 11 is thereby vacuum-sealed. The bellows 14 is fixed to the movable-side end plate 11c.

The fixed axis 12 is fixed to the central hole in the fixed-side end plate 11b with the fixed electrode 12a disposed in the vacuum vessel 11, and the movable axis 13 is fixed to the central hole in the bellows 14 with the movable electrode 13a disposed in the vacuum vessel 11; the vacuum valve 10 is thereby hermetically sealed. The contact 15, which is formed by the fixed electrode 12a and movable electrode 13a in the vacuum valve 10 while its inside is kept under vacuum, can be opened and closed.

The conductor 21 is electrically and mechanically connected to the fixed axis 12 of the vacuum valve 10 and fixed at one end, and forms part of a connection terminal at the other end. The conductor 21 is exposed at a pull-out opening 27a of the bushing 27, enabling an electrical connection to the conductor 21.

The fixed-electrode-side electric field concentration alleviating shield 22 is a ring, through which the fixed axis 12 passes, is disposed near the fixed-side end plate 11b of the vacuum valve 10 so as to be concentric with the vacuum valve 10.

The movable-electrode-side electric field concentration alleviating shield 23 is a ring, through which the movable axis 13 passes, is disposed near the movable-side end plate 11c of the vacuum valve 10 so as to be concentric with the vacuum valve 10.

The conductor electric field concentration alleviating shield 24 is a ring, through which the conductor 21 passes, is disposed near the pull-out opening 27a in the bushing 27 on the connection terminal side of the conductor 21.

The buffer layers 25 cover the outer peripheries of the vacuum valve 10 and conductor 21 to prevent direct contact between the vacuum valve 10 and resin insulator 26 and between the conductor 21 and resin insulator 26. The buffer layer 25 will be described later.

The resin insulator 26 is integrally formed by casting and curing insulating resin such as epoxy resin. The resin insulator 26 allows the movable axis 13 of the vacuum valve 10 to be movable and buries and fixes the fixed axis 12 of the vacuum valve 10, the vacuum vessel 11, the conductor 21, the fixed-electrode-side electric field concentration alleviating shield 22, the movable-electrode-side electric field concentration alleviating shield 23, and the conductor electric field concentration alleviating shield 24 there inside.

The buffer layers 25 prevent the integrally formed resin-molded vacuum valve 1 from suffering from cracks and exfoliation, which will be described below.

As for the resin-molded vacuum valve 1, the buffer layers 25 is formed on the outer surfaces of the vacuum valve 10 and conductor 21 by applying flexible resin, for example, with a brush, by spraying, or by casting and curing.

Furthermore, the fixed-electrode-side electric field concentration alleviating shield 22, movable-electrode-side electric field concentration alleviating shield 23, and conductor electric field concentration alleviating shield 24, which are metal inserts, are placed in metal molds together with the vacuum valve 10 and conductor 21 with the buffer layers 25 and then the insulating resin is cast so that the resin insulator 26 is formed on the outer surfaces of the buffer layers 25.

If conductive buffer layers (not shown) are also formed on the fixed-electrode-side electric field concentration alleviating shield 22, the movable-electrode-side electric field concentration alleviating shield 23, and the conductor electric field concentration alleviating shield 24, which are metal inserts, not only the resistance to cracks is improved but also partial discharges can be prevented between energized parts and the ground because even if voids, interfacial exfoliation, and other problems locally occur, the voids and exfoliated parts have the same potential as the metal inserts. Accordingly, when the resin insulator 26 is formed, it is preferable to form conductive buffer layers also on the fixed-electrode-side electric field concentration alleviating shield 22, the movable-electrode-side electric field concentration alleviating shield 23, and the conductor electric field concentration alleviating shield 24, which are metal inserts, before the insulating resin is cast.

The resin insulator 26, which integrally covers the vacuum valve 10, conductor 21, and metal inserts on which the buffer layers 25 are formed, should be made of epoxy resin that is easy to mold and has superior physical properties, stable chemical properties, and has established many track records. As an example, the resin insulator 26 is formed as follows: a compounding agent including bisphenol-A epoxy resin used as a base resin, an acid anhydride curing agent, and a modified acid anhydride curing agent are mixed with fine silica powder and short glass fiber, which are used as a filler; the resulting mixture is blended in a cast resin composition so that the mixture occupies at least 50% of the entire volume, after which tertiary amine is added as an accelerator by a prescribed amount and curing is performed under prescribed conditions.

In an exemplary manufacturing method, layers of flexible resin including silicone rubber particles are formed as the buffer layers 25 by casting on the outer peripheries of the vacuum valve 10, conductor 21, and metal inserts, and then the resin insulator 26 is formed with the above composition also by casting.

In another exemplary manufacturing method, an insulated reinforcement cylinder (not shown) is formed with the above composition in advance, the vacuum valve 10 is incorporated in the insulated reinforcement cylinder, and layers of flexible resin including silicone rubber particles are formed by potting to finally form the resin insulator 26.

Another example of the resin insulator 26 for integral covering may be formed from glycidyl ester epoxy resin that includes an acid anhydride curing agent, an organic metal compound curing accelerator, and an inorganic filler such as amorphous molten quartz to which surface improvement processing has been applied by using a titanate coupling agent; to improve resistance to cracks, resin linear expansion coefficient, which affects resistance to cracks, initial viscosity, which affects workability, and other parameters, are appropriately selected with temperature, humidity, curing time, a composition blending ratio, and other curing conditions taken into consideration.

There is no limitation on the buffer layers 25, if it matches the resin insulator 26. Silicone rubber particles were used to form the buffer layers 25 in this embodiment because they have superior heat resistance. However, even if plastic resin layers that includes any one of silicone rubber particles that have superior adhesiveness, acrylic resin particles, nylon particles, urethane resin particles, and the like are used to form the buffer layers 25, the same effect in improvement in destruction toughness is obtained and thereby stress alleviation becomes possible, depending on the conditions under which the apparatus is used.

If the resin-molded vacuum valve 1 lacks the buffer layer 25, when the resin-molded vacuum valve 1 is rapidly heated or cooled, a force is applied to the resin insulator 26 due to thermal stress caused by a difference in thermal expansion coefficients between the vacuum vessel 11 and resin insulator 26 and a difference in thermal expansion coefficients between the conductor 21 and resin insulator 26. An impact force is also applied to the resin insulator 26 in an open or close operation. When this happens, cracks, interfacial exfoliation, and other problems are likely to occur, substantially lowering the product reliability of the resin-molded vacuum valve 1.

In this embodiment, however, the buffer layers 25 disposed between the vacuum vessel 11 and resin insulator 26 and between the conductor 21 and resin insulator 26 lower the risk of the occurrence of cracks and exfoliation.

More preferably, if conductive buffer layers (not shown) are provided between the fixed-electrode-side electric field concentration alleviating shield 22 and resin insulator 26, between the movable-electrode-side electric field concentration alleviating shield 23 and resin insulator 26, and between the conductor electric field concentration alleviating shield 24 and resin insulator 26, these electric field concentration alleviating shields being metal inserts, the risk of the occurrence of cracks and exfoliation is further lowered. Accordingly, the resin-molded vacuum valve 1 has further improved resistance to cracks.

Since the fixed-electrode-side electric field concentration alleviating shield 22, movable-electrode-side electric field concentration alleviating shield 23, and conductor electric field concentration alleviating shield 24 suppress partial discharges generated due to the electric field concentration, the risk of the occurrence of cracks and exfoliation is also reduced, further improving resistance to cracks.

The resin-molded vacuum valve 1 of this type enables a high vacuum condition to be formed in the vacuum vessel 11 of the vacuum valve 10, producing a superior dielectric strength against a high voltage. In the high vacuum in the vacuum vessel 11, even when an arc is generated when the contact 15 opens or closes, the arc disappears immediately, shutting off a high voltage circuit. The resin-molded vacuum valve 1 in this embodiment is as described above.

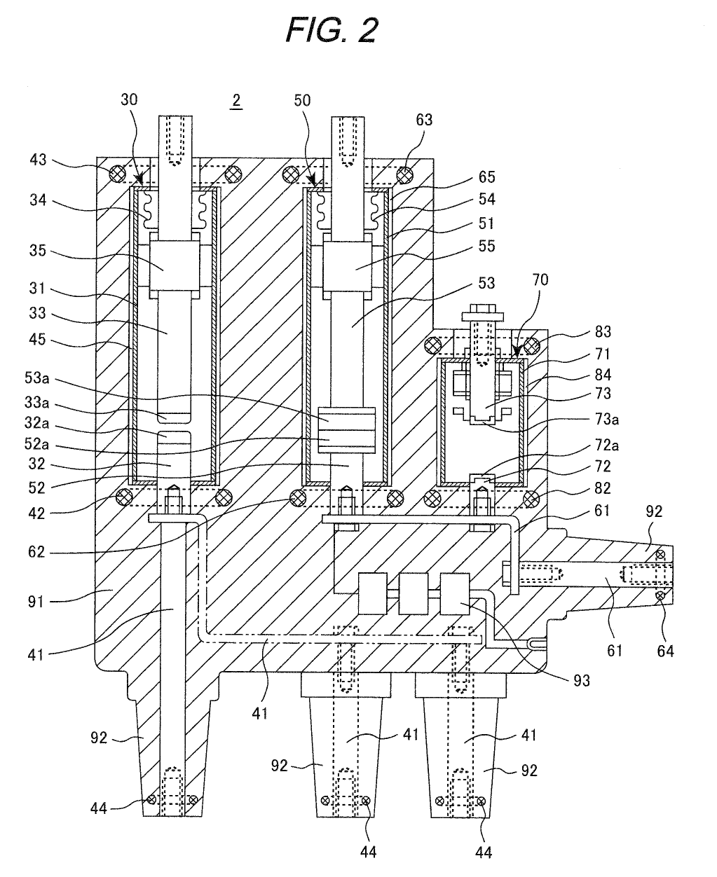

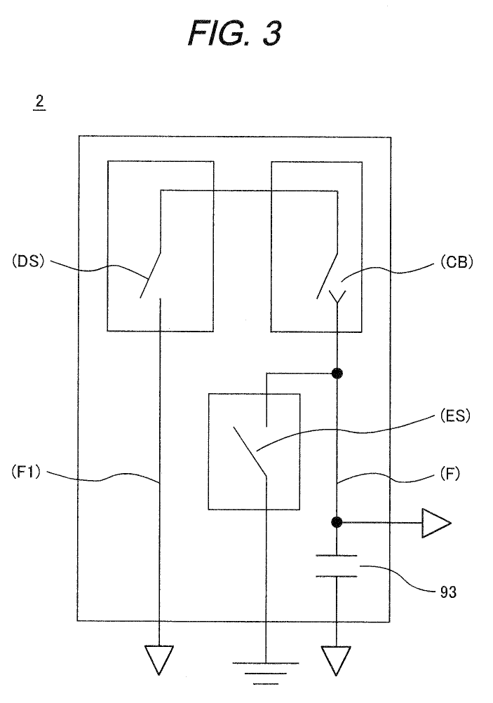

Next, a resin-molded vacuum valve 2 in a second embodiment of the present invention will be described with reference to the drawings. FIG. 2 illustrates the structure of the resin-molded vacuum valve in the second embodiment of the present invention, and FIG. 3 is a circuit block diagram of the resin-molded vacuum valve of the second embodiment shown in FIG. 2.

As shown in FIG. 2, the resin-molded vacuum valve 2 includes a first vacuum valve 30, branch buses 41, a first fixed-electrode-side electric field alleviating shield 42, a first movable-electrode-side electric field alleviating shield 43, a branch bus electric field alleviating shield 44, a buffer layer 45, a second vacuum valve 50, a feeder conductor 61, a second fixed-electrode-side electric field alleviating shield 62, a second movable-electrode-side electric field alleviating shield 63, a feeder conductor electric field alleviating shield 64, a buffer layer 65, a third vacuum valve 70, a third fixed-electrode-side electric field alleviating shield 82, a third movable-electrode-side electric field alleviating shield 83, a buffer layer 84, a resin insulator 91, a bushing 92, and a voltage divider 93.

The first vacuum valve 30 (disconnecting switch DS) has a vacuum vessel 31, a fixed axis 32, a movable axis 33, a bellows 34, and an axis support 35. The fixed axis 32 has a fixed electrode 32a and the movable axis 33 has a movable electrode 33a, forming a first contact by these fixed electrode 32a and movable electrode 33a.

The second vacuum valve 50 (circuit breaker CB) has a vacuum vessel 51, a fixed axis 52, a movable axis 53, a bellows 54, and an axis support 55. The fixed axis 52 has a fixed electrode 52a and the movable axis 53 has a movable electrode 53a, forming a second contact by these fixed electrode 52a and movable electrode 53a.

The third vacuum valve 70 (earth switch ES) has a vacuum vessel 71, a fixed axis 72, and a movable axis 73. The fixed axis 72 has a fixed electrode 72a and the movable axis 73 has a movable electrode 73a, forming a third contact by these fixed electrode 72a and movable electrode 73a.

In the vacuum vessel 31 of the first vacuum valve 30, the fixed electrode 32a integrally formed at an end of the fixed axis 32 and the movable electrode 33a integrally formed at an end of the movable axis 33 are disposed facing each other. The fixed axis 32 connected to the branch bus 41 is fixed to the vacuum vessel 31. The movable axis 33 is slidably supported in the vertical direction by the axis support 35 and attached so as to be made movable by the bellows 34. The bellows 34 has a bag-like shape as with the bellows 14, which has been described with reference to FIG. 1; the bellows 34 has a reduced number of sealed parts to increase the reliability of the vacuum hermetic seal. The vacuum vessel 31 and bellows 34 hermetically seal the inside of the first vacuum valve 30 and maintain a vacuum. The first contact formed in the first vacuum valve 30 by the fixed electrode 32a and movable electrode 33a can be opened and closed. The movable axis 33 is linked to an open/close operation mechanism, for opening and closing a load, which comprises a rod, a link, and other components (for convenience, the movable axis 33 and open/close operation mechanism are collectively called the first linking seat).

In the vacuum vessel 51 of the second vacuum valve 50, the fixed electrode 52a integrally formed at an end of the fixed axis 52 and the movable electrode 53a integrally formed at an end of the movable axis 53 are disposed facing each other. The fixed axis 52 connected to the feeder conductor 61 is fixed to the vacuum vessel 51. The movable axis 53 is slidably supported in the vertical direction by the axis support 55 and attached so as to be made movable by the bellows 54. The bellows 54 has a bag-like shape as with the bellows 14, which has been described with reference to FIG. 1; the bellows 54 has a reduced number of sealed parts to increase the reliability of the vacuum hermetic seal. The vacuum vessel 51 and bellows 54 hermetically seal the inside of the second vacuum valve 50 and maintain a vacuum. The second contact formed in the second vacuum valve 50 by the fixed electrode 52a and movable electrode 53a can be opened and closed. The movable axis 53 is linked to an open/close operation mechanism, for opening and closing a load, which comprises a rod, a link, and other components (for convenience, the movable axis 53 and open/close operation mechanism are collectively called the second linking seat).

In the vacuum vessel 71 of the third vacuum valve 70, the fixed electrode 72a integrally formed at an end of the fixed axis 72 and the movable electrode 73a integrally formed at an end of the movable axis 73 are disposed facing each other. The fixed axis 72 connected to the feeder conductor 61 is fixed to the vacuum vessel 71. The movable axis 73 is slidably supported in the vertical direction. The vacuum vessel 71 hermetically seals the inside of the third vacuum valve 70 and maintains a vacuum. The third contact formed in the third vacuum valve 70 by the fixed electrode 72a and movable electrode 73a can be opened and closed. The movable axis 73 is linked to an open/close operation mechanism, for opening and closing a load, which comprises a rod, a link, and other components (for convenience, the movable axis 73 and open/close operation mechanism are collectively called the third linking seat). The movable axis 73 of the earth switch is connected to the ground bus.

At the side opposite to the fixed electrode of the feeder conductor 61, the bushing 92 that is a feeder terminal seat is laterally oriented, apart from the resin-molded vacuum valve 2. At the side opposite to the fixed electrode of the branch bus 41, the bushing 92 that is a bus terminal seat is downwardly oriented, apart from the resin-molded vacuum valve 2. These bushings are disposed outside the resin-molded vacuum valve 2. The voltage divider 93 is formed by connecting a plurality of ceramic capacitors in series, which is connected to the feeder conductor 61.

In this embodiment, a phase-separated structure is used (for example, the branch bus 41 indicated by the solid lines in FIG. 2 is the U phase, and the other branch buses 41 indicated by the dotted lines are the V and W phases), so, in the case of the three phases, it suffices to dispose resin-molded vacuum valves 2 side by side.

Although not shown in the drawing, the movable axis 33 in the first vacuum valve 30 for a disconnecting switch and the movable axis 53 in the second vacuum valve 50 for a circuit breaker may be mutually connected, for example, through a flexible conductor that moves together with the movable axis 33 and movable axis 53 in an appropriate location regardless of whether the location is inside or outside the resin-molded vacuum valve 2, so that the movable axis 33 and movable axis 53 move together with another constituent unit.

Although not shown in the drawing again, conductive layers (not shown) are also formed on the branch bus 41, first fixed-electrode-side electric field alleviating shield 42, first movable-electrode-side electric field alleviating shield 43, branch bus electric field alleviating shield 44, feeder conductor 61, second fixed-electrode-side electric field alleviating shield 62, second movable-electrode-side electric field alleviating shield 63, feeder conductor electric field alleviating shield 64, third fixed-electrode-side electric field alleviating shield 82, third movable-electrode-side electric field alleviating shield 83, and voltage divider 93, and not only the resistance to cracks is improved but also partial discharges can be prevented between energized parts and the ground because even if voids, interfacial exfoliation, and other problems locally occur, the voids and exfoliated parts have the same potential as the metal inserts.

Next, the block circuit of the resin-molded vacuum valve 2 will be described with reference to the drawings. The resin-molded vacuum valve 2 in FIG. 2 has an electric circuit, as shown in FIG. 3, for a cubicle-type switching apparatus. In FIG. 3, the resin-molded vacuum valve 2 includes a disconnecting switch (DS), which generally constitutes a vacuum switch, a circuit breaker (CB), which generally constitutes a vacuum switch, an earth switch (ES), which generally constitutes a vacuum switch, a branch bus (F1) connected to the fixed electrode of the disconnecting switch (DS), a feeder conductor (F) connected to the fixed electrodes of the circuit breaker (CB) and the earth switch (ES), and the voltage divider 93 formed by connecting a plurality of ceramic capacitors in series, which manages voltages of capacitors and other components connected to the feeder conductor (F).

The disconnecting switch (DS) constituting a vacuum switch is the first vacuum valve 30, the circuit breaker (CB) constituting another vacuum switch is the second vacuum valve 50, and the earth switch (ES) constituting yet another vacuum switch is the third vacuum valve 70.

Although not shown in the drawing again, while the bus terminal seat, feeder terminal seat, connection terminal, and linking seats connected or linked to another constituent unit are in the state in which they are externally disposed, the disconnecting switch (DS), the circuit breaker (CB), the earth switch (ES), the branch bus (F1), the feeder conductor (F), and the voltage divider 93 are integrally molded with epoxy.

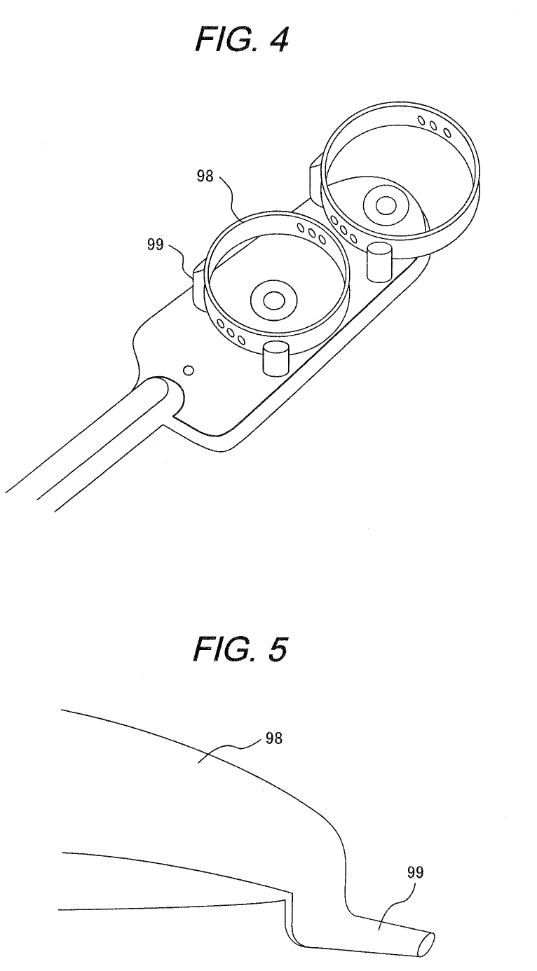

In FIG. 4, as an example of the electric field concentration alleviating shield in the embodiment, a metallic ring-shaped electric field concentration alleviating shield 98 is provided with locking projections 99 (see FIG. 5), which are externally formed in radial directions of the ring-shaped electric field concentration alleviating shield 98 to snap into concave parts (not shown) of a separately prepared metal mold and to dispose the electric field concentration alleviating shield 98 around its outer periphery with the electric field concentration alleviating shield 98 buried in epoxy resin. This manufacturing method not only suppresses partial discharges generated by electric field concentration due to the insert shape, but also enables placement in the metal mold to be simplified and work man-hours to be reduced.

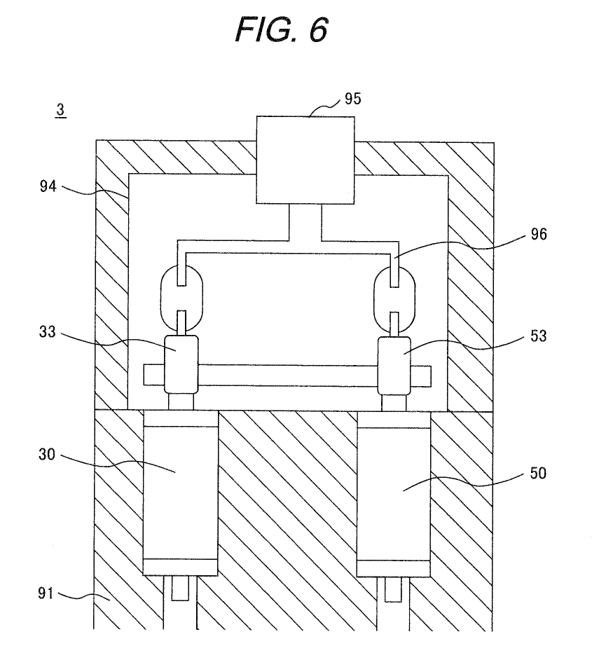

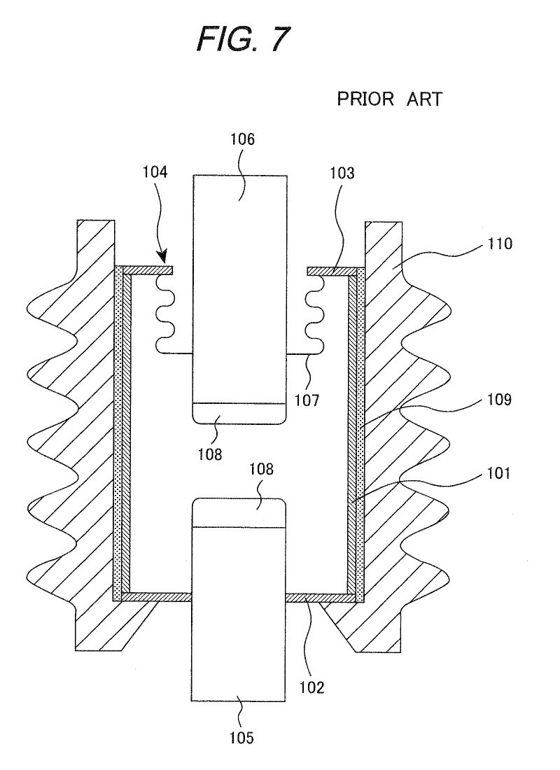

Next, a resin-molded vacuum valve 3 in a third embodiment of the present invention will be described with reference to the drawings. FIG. 6 shows the structure of the resin-molded vacuum valve 3 in the third embodiment of the present invention, in which a linkage axis is further provided between the movable axes of the first vacuum valve 30 and second vacuum valve 50 of the resin-molded vacuum valve 2 in the second embodiment illustrated in FIG. 2. FIG. 6 only shows important parts because the other structure is identical to the corresponding structure of the resin-molded vacuum valve 2 illustrated in FIG. 2; the following description will focus on added features and duplicate descriptions will be omitted.

In FIG. 6, a resin insulator 91 of the resin-molded vacuum valve 3 in the third embodiment including a common cover 94 is further provided around the first vacuum valve 30 and second vacuum valve 50 of the resin-molded vacuum valve 2 in the second embodiment as shown in FIG. 2. The openings formed atop the first vacuum valve 30 and second vacuum valve 50 are hermetically sealed by the common cover 94, which accommodates the movable axis 33 of the first vacuum valve 30, the movable axis 53 of the second vacuum valve 50, and the linkage axis 96, which moves together with the movable axis 33 and movable axis 53. The linkage axis 96 provided with branch axes, one of which is connected with the movable axis 33 of the first vacuum valve 30 and other is connected with the movable axis 53 of the second vacuum valve 50, respectively. The linkage axis 96 is linked to an opening/closing mechanism 95 provided on the top at the center. The linkage axis 96 drives the first vacuum valve 30 and second vacuum valve 50 so that they can move away from and approach the respective valves. A conductive buffer layer (not shown) is also provided around the outer periphery of the common cover 94 to reduce the risk of the occurrence of cracks and exfoliation and improve resistance to cracks on arbitrary resin molded shapes depending on the shapes of the inserts with large variations in final dimensions, such as vacuum valves.

That is, to achieve a compact structure, the movable axes 33, 53 on the first vacuum valve 30 and second vacuum valve 50 are made identical and the first linking seat and second linking seat are made identical. Due to this structural consideration, the amount of integrally covering epoxy resin is also reduced.

1. A resin-molded vacuum valve, comprising:
a vacuum valve having an internally hermetically sealed vacuum vessel, a fixed axis having a fixed electrode at an end, and a movable axis having a movable electrode at an end, wherein the fixed electrode and the movable electrode are facing each other in the vacuum vessel, the fixed electrode being fixed to an end of the vacuum vessel, the movable electrode being movably attached to another end of the vacuum vessel, and a contact being formed between the fixed electrode and the movable electrode;
a conductor connected to the fixed axis of the vacuum valve and externally extending from a pull-out opening;
a first electric field concentration alleviating shield disposed near the fixed axis of the vacuum valve;
a second electric field concentration alleviating shield disposed near the movable axis of the vacuum valve;
a third electric field concentration alleviating shield disposed near the pull-out opening through which the conductor externally extends;
buffer layers covering the outer peripheries of the vacuum valve and the conductor; and
a resin insulator allowing the movable axis of the vacuum valve to be movable and burying and fixing the fixed axis of the vacuum valve, the vacuum vessel of the vacuum valve, the conductor, the buffer layers, and the electric field concentration alleviating shields there inside.

2. A resin-molded vacuum valve, comprising:
a first vacuum valve having a first vacuum vessel, a fixed electrode, and a movable electrode, a first contact, to which the fixed electrode and the movable electrode face, being formed in the first vacuum vessel;
a second vacuum valve having a second vacuum vessel, a fixed electrode, and a movable electrode, a second contact, to which the fixed electrode and the movable electrode face, being formed in the second vacuum vessel;
a third vacuum valve having a third vacuum vessel, a fixed electrode, and a movable electrode, a third contact, to which the fixed electrode and the movable electrode face, being formed in the third vacuum vessel;
a branch bus connected to the fixed axis of the first vacuum valve and externally extending from a pull-out port;
a feeder conductor connected to the fixed axis of the second vacuum valve and the fixed axis of the third vacuum valve and externally extending from another pull-out port;
a first electric field concentration alleviating shield disposed near the fixed axis of the first vacuum valve;
a second electric field concentration alleviating shield disposed near the movable axis of the first vacuum valve;
a third electric field concentration alleviating shield disposed near the fixed axis of the second vacuum valve;
a fourth electric field concentration alleviating shield disposed near the movable axis of the second vacuum valve;
a fifth electric field concentration alleviating shield disposed near the fixed axis of the third vacuum valve;
a sixth electric field concentration alleviating shield disposed near the movable axis of the third vacuum valve;
a seventh electric field concentration alleviating shield disposed near the pull-out opening near the branch bus;
a eighth electric field concentration alleviating shield disposed near the other pull-out opening near the feeder conductor;
buffer layers covering the outer peripheries of the first, second, and third vacuum valves, the branch bus, and the feeder conductor; and
a resin insulator allowing the movable axes of the first, second, and third vacuum valves to be movable and burying and fixing the fixed axes of the first, second, and third vacuum valves, the vacuum vessels of the first, second, and third vacuum valves, the branch bus, the feeder conductor, the buffer layers, and the electric field concentration alleviating shields there inside.

3. The resin-molded vacuum valve according to claim 2, further comprising a common cover for being communicated with the vacuum vessels of the first and second vacuum valves and internally hermetically sealed; and
a linkage axis having branched axes, one of which is connected with the movable axis of the first vacuum valve and other is connected with the movable axis of the second vacuum valve, and linked to an opening/closing mechanism,
wherein:
the buffer layers covering the outer peripheries of the first, second, and third vacuum valves, the branch bus, the feeder conductor, and the common cover; and
the resin insulator allowing the movable axes of the first, second, and third vacuum valves, to be movable and burying and fixing the fixed axes of the first, second, and third vacuum valves, the vacuum vessels of the first, second, and third vacuum valves, the common cover, the branch bus, the feeder conductor, the buffer layers, and the first, second, third, fourth, fifth, sixth, seventh and eighth electric field concentration alleviating shields there inside.

4. The resin-molded vacuum valve according to claim 1, wherein the resin insulator is made of epoxy resin.

5. The resin-molded vacuum valve according to claim 1, wherein each electric field concentration alleviating shield is a metallic ring-shaped electric field concentration alleviating shield that has locking projections in radial directions so as to be fixed and held.

6. The resin-molded vacuum valve according to claim 1, wherein the buffer layers are conductive buffer layers.

7. The resin-molded vacuum valve according to claim 1, wherein each electric field concentration alleviating shield has a buffer layer around a periphery thereof.

8. The resin-molded vacuum valve according to claim 2, wherein:
the first vacuum valve is a disconnecting switch;
the second vacuum valve is a circuit breaker;
the third vacuum valve is an earth switch; and
the resin-molded vacuum valve is used in a cubicle-type switching apparatus.

9. The resin-molded vacuum valve according to claim 2, further comprising a voltage divider, which is connected to the feeder conductor at one end and connected to a connection terminal at another end, and the voltage divider being buried in the resin insulator in parallel to the third vacuum valve.

10. The resin-molded vacuum valve according to claim 9, wherein:
the voltage divider comprises a ceramic capacitor.

11. The resin-molded vacuum valve according to claim 9, wherein:
the voltage divider is formed by connecting a plurality of ceramic capacitors in series.
